(19) United States
(12) Patent Application Publication
(10) Pub. No.: US 2013/0224340 A1
(43) Pub. Date: Aug. 29, 2013

(54) OPTIMAL EXTRACTION RATE COFFEE CAPSULE WITH EFFECTIVE SEAL FOR DIVERSE GROUP HEADS

(71) Applicant: Hanan BenDavid, Kfar Saba (IL)

(72) Inventor: Hanan BenDavid, Kfar Saba (IL)

(21) Appl. No.: 13/405,409

(22) Filed: Feb. 27, 2012

(51) Int. Cl. B65D 85/804; A23F 5/36

(52) U.S. Cl. 426/112; 426/394

(57) ABSTRACT

A coffee capsule for placement in a group head of espresso-making machines may produce espresso like that made by baristas. The capsule has a body wall, a curved top with a circumferential strip of reduced thickness configured for puncture and a circular flange projecting outward from the bottom end of the body wall. The capsules seals tightly with the group head against water leakage and produces espresso of optimal extraction rate due to one or more of the following: the thickness of the flange, the proximal ridge and small step on the flange, the outer step adjacent the body wall projecting upward from the bottom end of the body wall In addition, the coffee capsule may be made of polypropylene copolymer TR-50 and preferably about 80% TR-50 to also facilitate sealing. The flange has a pre-welding diameter calculated to expand to about 37 mm after being welded to the lid.

### FIELD AND BACKGROUND OF THE INVENTION

The present invention relates to apparatuses and methods for capsules used in coffee-making making machines and, more particularly to such capsules for espresso designed for optimal extraction rate and usable in a diverse variety of group heads.

In the process of coffee preparation using a coffee-making machine, one step in the process is utilization of a capsule containing coffee granules. The coffee granules in the capsule are subjected to a flow of heated water. As the water flows through the capsule, it is hoped that the water is evenly distributed throughout the capsule. Furthermore, according to coffee baristas, there is an optimal extraction rate for espresso. Achieving the ideal extraction rate is an art. It has been found to be in the ballpark of 0.20, which means about a 20% solubility rate of the solute, namely the granules, in the solvent, namely the water.

There are two ways to make espresso. The first is to use a professional barista who, like a bartender, artfully mixes the ingredients over a relatively long amount of time to create the ideal espresso using a professional espresso-making machine. This is an art. The second way is to use an espresso-making machine that utilizes a coffee capsule. The advantage of making the espresso with a coffee capsule is that it is easier, cleaner and more standardized. The cost of the barista is also saved. The drawbacks include the fact that this method does not achieve as high a quality of espresso, whether measured by taste, flow or other subjective criteria. This outcome may be because when using the coffee capsule to make the espresso, the hot water is applied to the coffee granules for a very short time, as compared to the much longer period of exposure time when the professional barista makes espresso. Furthermore, the artistry and professional skill and experience of the barista is not available when using a coffee capsule.

A further technical problem with making espresso using a coffee capsule is ensuring that the coffee capsule that fits into the group head does not leak water and that the capsule does not get stuck in the group head. If the capsule does leak water, less coffee comes out of the brewing process and into the espresso. Furthermore, control is then lost over the exact percentage of water that should be present as an ingredient of the espresso and the optimal extraction rate cannot be achieved.

A further problem of making espresso using a coffee capsule is that a large manufacturer of coffee-making machines for espresso may have multiple types of group heads for their espresso making machines. For example, Societe Des Produits Nestle S.A. has several different group heads each having different structural characteristics and/or dimensions. Certain large manufacturers of coffee making machines deliberately make it difficult for coffee capsules not made by or for that manufacturer to be usable, for example so as to seal effectively, in the group heads of their machines. Furthermore, these manufacturers may it exceedingly difficult to create a coffee capsule that works in more than one of their group heads, and certainly not in all of them. This makes it impossible for a coffee capsule usable in one type of group head for one espresso making machine to be also usable in the group head of the other machines. Having to create separate coffee capsules for separate group heads significantly increases the manufacturer costs of espresso making.

Another technical problem is that the blades of the group head puncture the top of the coffee capsule. If the top of the coffee capsule is too soft, the puncture will not be easy and simple whereas if the coffee capsule is made from material that is too hard, it will be that much more difficult to achieve an effective seal against water leakage.

There is therefore a compelling need to have a method and/or apparatus for making espresso utilizing a coffee capsule (and hence enjoying all the advantages associated with the use of coffee capsules such as those mentioned above) without suffering from the drawbacks associated with making espresso using coffee capsules, such as the above-mentioned drawbacks and to thereby create espresso of the quality produced by professional baristas.

### SUMMARY OF THE PRESENT INVENTION

One aspect of the present invention is a coffee capsule for placement in a group head of a coffee-making machine and having an optimal extraction rate, comprising a substantially circular body wall defining a hollow space and having a top end and a bottom end; a curved top meeting the top end of the body wall, the curved top configured for puncture to define water inlets; a circular flange projecting outward from the bottom end of the body wall and configured to mate with an outer portion of a lid, the flange having a proximal ridge protruding from a surface of the flange and forming a seal against water from the group head.

A further aspect of the present invention is a coffee capsule for placement in a group head of a coffee-making machine and having an optimal extraction rate, comprising a substantially circular body wall defining a hollow space and having a top end and a bottom end; a curved top meeting the top end of the body wall, the curved top accessible for puncture to define water inlets; a circular flange projecting from the bottom end of the body wall to mate with an outer portion of a lid, a thickness of the flange ranging from 0.5 mm to 1.1 mm, the coffee capsule formed of flexible polyproylene copolymer comprising TR50.

A still further aspect of the present invention is A method of preparing a group head of a coffee-making machine to brew espresso having an optimal extraction rate, comprising forming a coffee capsule from about 80% TR-50 polyproylene copolymer and about 20% R-50 polyproylene copolymer; positioning the coffee capsule in the group head; and sealing the coffee capsule against the group head.

A yet still further aspect of the present invention is a method of making a coffee capsule, comprising providing a coffee capsule having a substantially circular body wall, the body wall defining a hollow space and having a top end and a bottom end, a curved top meeting the top end of the body wall, a circular flange projecting from the bottom end of the body wall, the coffee capsule comprising a polypropylene copolymer; attaching a lid to a coffee capsule so that the flange mates with a distal portion of the lid; and forming the flange with an initial diameter of between about 36.2 to about 36.6 mm calculated before the flange is attached to the lid so that after the flange is attached to the lid a subsequent diameter of the flange is from about 36.8 mm to about 37.1 mm in diameter.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a front view of a coffee capsule used in an espresso-making machine, in accordance with one embodiment of the present invention;

FIG. 2 is a vertical sectional view of the coffee capsule of FIG. 1, in accordance with one embodiment of the present invention;

FIG. 3 is a top view of the coffee capsule of FIG. 1, in accordance with one embodiment of the present invention;

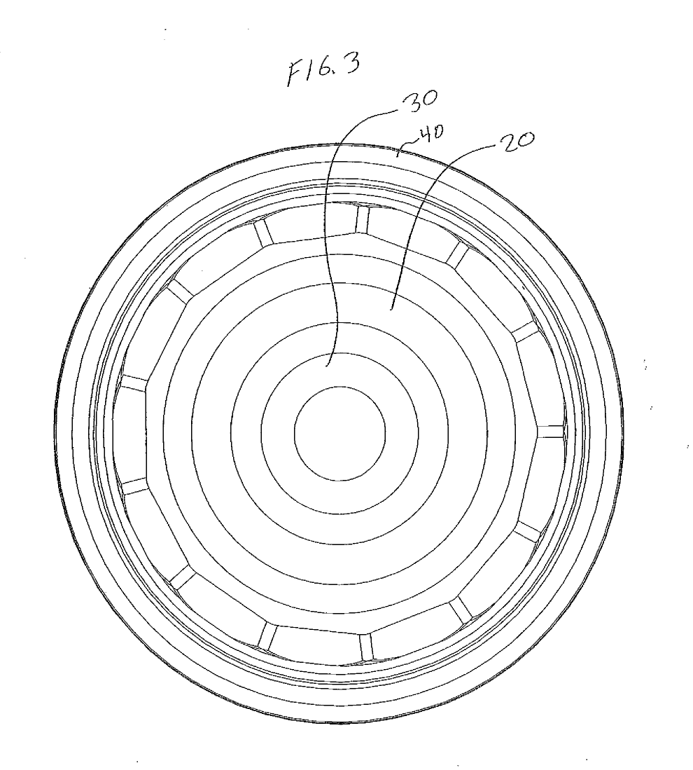

FIG. 4 is a bottom view of the coffee capsule of FIG. 1, in accordance with one embodiment of the present invention;

FIG. 5 is a flow chart showing a method of the present invention; and

FIG. 6 is a flow chart showing a further method of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a coffee capsule for placement in a group head of a coffee-making machine, and in particular in a machine for making espresso at an optimal extraction rate. The coffee capsule may have a substantially circular body wall defining a hollow space and having a top end and a bottom end. The capsule may have a curved top meeting the top end of the body wall, the curved top may have a circumferential strip of reduced thickness for convenient puncturing by blades of the water head to define water inlets. The capsule may also have a circular flange projecting outward from the bottom end of the body wall and configured to mate with an outer portion of a lid. Certain details of the flange may facilitate a tight seal with the group head against water leakage. For example, the flange may be about 0.5 mm to about 1.1 mm thick and may have a proximal ridge protruding from a surface of the flange. The flange may also have an outer step adjacent the body wall and projecting upward from the bottom end of the body wall. A small step may be situated between the ridge and the outer step, the small step being smaller than the ridge and the outer step. The coffee capsule may be made of polypropylene copolymer comprising TR50. The diameter of the flange may be calculated so that after expansion from being welded to the lid, the flange diameter reaches about 37 mm.

In contrast to prior art coffee capsules, which may fit onto a group head of one particular espresso-making machine, the coffee capsule of the present invention may fit and seal effectively onto multiple types of group heads. For example the coffee capsule of the present invention may fit and seal effectively, without leakage of the pressurized water, onto the several types of group heads of espresso preparation machines of Societe Des Produits Nestle S.A. Furthermore, in contrast to coffee capsules for espresso making machines that may seal only with the existence of a separate gasket element, such as one made of silicone, which may come off from time to time, the coffee capsule of the present invention may achieve the effective seal referred to without the use of a separate gasket piece. Instead, the single integral unitary piece of material of the capsule itself (excluding the lid) may achieve this seal by its shape and by the material it is made from. In further contrast to the prior art coffee capsules, that may be made of aluminum, the coffee capsule of the present invention may be made of a polyproylene copolymer, for example one that comprises TR50 (and in some preferred embodiments about 80% TR-50 and about 20% R-50). As a result of one or more of the above structural and material characteristics, the espresso may taste better, flow better and achieve the outcome and quality of espresso made by skilled baristas using a professional espresso-making machine. The present invention many thereby achieve the advantages of the professionally made espresso combined with the advantages of the method using capsules, without the disadvantages of each In contrast to prior art coffee capsules, in which the curved top of the capsule is of uniform thickness, the curved top of the coffee capsule of the present invention may have a circumferential strip of reduced thickness for optimal puncturing by the blades of the group head. For example, the thickness may be about 0.3 to about 0.45 mm instead of the thickness of about 0.5 to about 0.8 mm at the lower portion of the curved top of the capsule. In still further contrast to the prior art coffee capsules, wherein the flange (that mates with the lid) may be of uniform thickness, the flange of the coffee capsule of the present invention may have specially designed irregularities. For example, the flange may have a proximal ridge, may have an outer step adjacent the body wall projecting from where the bottom end of the body wall meets the flange, and may have a smaller step between the ridge and outer step. Furthermore, these three specially designed irregularities may have a range of dimensions designed to optimize the effectiveness of the seal. In yet still further contrast to the flange of prior art coffee capsules, the thickness of the flange of the coffee capsule of the present invention may have a range of dimensions, for example about 0.5 mm to about 1.1 mm, that may facilitate optimizing the effective seal of the coffee capsule for a wide range of types of group heads, which may include group heads of different espresso making machine manufacturers. In contrast to prior art coffee capsules for espresso making machines, the height of the outer wall of the capsule of the present invention may be about 0.5 mm greater than standard capsules for group heads of espresso making machines of Societe Des Produits Nestle S.A. In further contrast to the prior art coffee capsules for espresso making machines, in which the diameter of the flange may be imperfect, the coffee capsule of the present invention may employ a flange having a pre-welding diameter (i.e. before the lid has been welded onto the flange) of between about 36.2 to 36.6 mm in order to achieve a post-welding diameter of about 37.0 mm, which may be an ideal diameter. In further contrast to prior art coffee capsules, the coffee capsule of the present invention may not get stuck in the group head. In further contrast to the material of prior art coffee capsules, which are either too hard for an effective seal with the group head, or too soft to allow easy and convenient puncturing by the blades of the group head, the coffee capsule of the present invention may be soft enough for an effective seal and hard enough for convenient and effective puncturing by utilizing TR-50 (and in some cases using about 80% TR-50 and about 20% R-50).

The principles and operation of a method and apparatus for an optimal extraction rate coffee capsule with effective seal for diverse group heads may be better understood with reference to the drawings and the accompanying description.

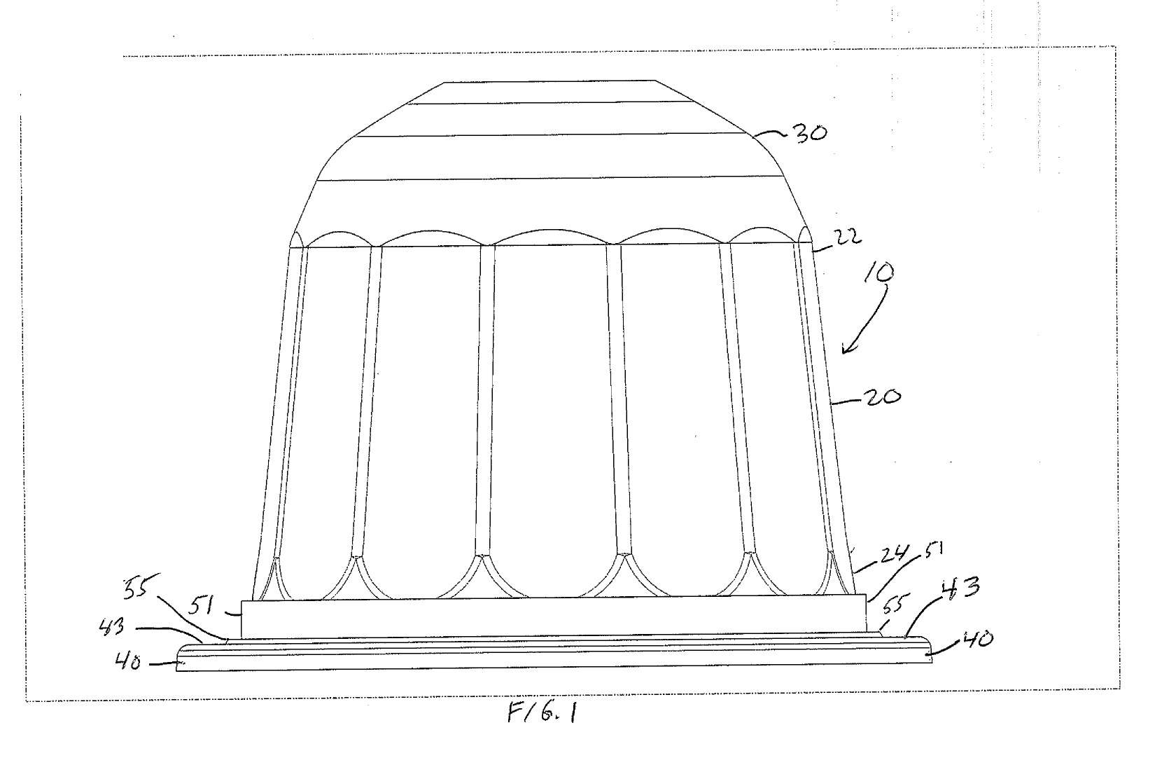

FIG. 1 is a side view of the coffee capsule of the present invention, in accordance with one embodiment. In some preferred embodiments, the coffee capsule is symmetrical such that FIG. 1 also represents a front and rear view of the coffee capsule. FIG. 1 depicts a coffee capsule 10 for placement in a group head of a coffee-making machine, for example for espresso. The coffee capsule 10 may achieve an optimal extraction rate. Coffee capsule 10 may comprise a substantially circular body wall 20 that defines a hollow space. The body wall 20 may have a top end 22 and a lower end 24, also called the bottom end 24 of body wall 20. The top end 22 of body wall 20 may meet a curved top 30 of capsule 10 and the lower end 24 may meet a flange 40 of capsule 10.

Capsule 10 may have a generally curved top 30 meeting the top end 22 of the body wall 20. The curved top 30 may have a lower portion 32, an upper portion 34 and a top portion 36. Although top portion 36 of curved top 30 may be generally flat, and may meet upper portion 34 at a corner 35, the overall appearance of curved top 30 is nonetheless generally curved. Top portion 36 may have a dimple or depression at its center. The curved top 30, and in particular the upper portion 34, may be accessible, while positioned in the group head, for puncture to define water inlets.

Capsule 10 may also comprise a circular flange 40 projecting outward (substantially perpendicularly from the body wall 20) from the bottom end 24 of body wall 20. Flange 40 may be configured so that is underside may mate with an outer portion of a lid (not shown). Flange 40 may have a proximal ridge 55 protruding from a top surface 43 of the flange 40 to form a seal against water from the group head (not shown) that surrounds capsule 10 in the coffee-making machine. In some embodiments, flange 40 also has a distal lip 41.

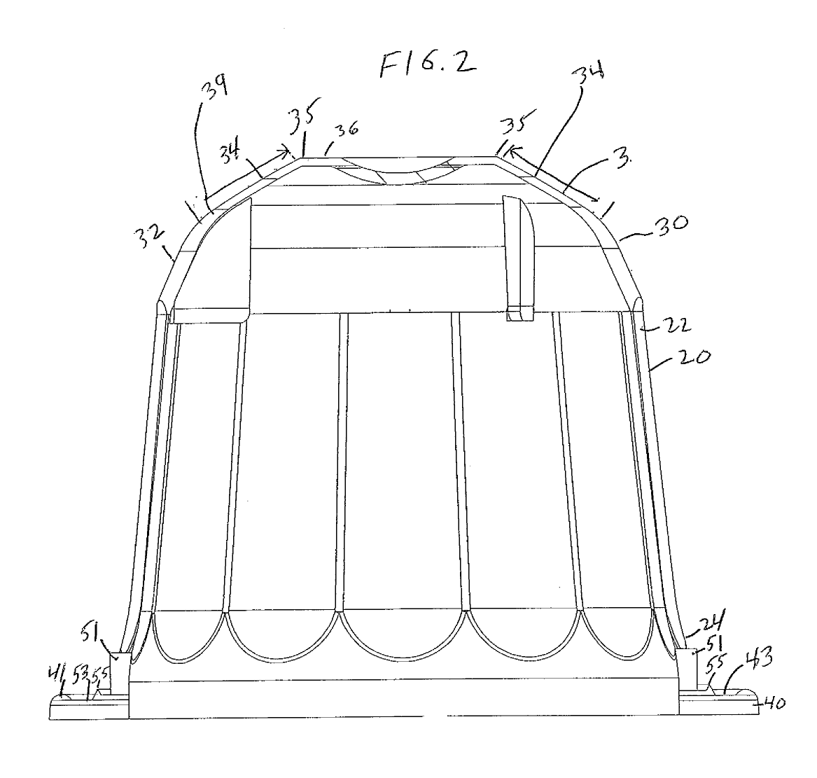

As seen from FIG. 2, the coffee capsule may further comprise an outer step 51 adjacent the body wall 20 projecting upward from the lower end 24 of the body wall 20. In addition, a small step 53 may be situated between the ridge 55 and the outer step 51. In order to effectuate the seal with the group head, the small step 53 may be smaller than ridge 55 and smaller than the outer step 51. Small step may have a perpendicular height above the upper surface 43 of flange 40 equal to between about 0.2 mm and about 0.5 mm.

Ridge 55 may have a perpendicular height above the upper surface 43 of flange 40 equal to between about 0.4 and about 0.7 mm. Outer step 51 may have a length alongside the body wall 20, and in particular the lower end 24 of body wall 20, of between about 2 mm to about 4 mm. As a result of the ridge 55, outer step 51 and small step 53, the group head (not shown) may seal tightly against capsule 10 without water leakage.

Coffee capsule (without the lid) may be formed of a plastic, for example a polypropylene copolymer plastic. The main copolymer may be a polyproylene material called TR50, which is somewhat flexible. Capsule 10 may comprise polyproylene copolymer TR-50. The present inventor has unexpectedly found that when TR-50 comprises about 80% of the copolymer and the other about 20% may be a harder polypropylene copolymer called R-50 in the polyproylene manufacturing industry, the coffee capsule 10 may be soft enough to allow the seal of the coffee capsule 10 with the group head to be very effective and enhanced yet hard enough to allow easy and effective puncturing of the curved top of the coffee capsule by the blades (not shown) of the group head (not shown).

In order to make it easy for the blades of the group head to puncture the curved top 30 of capsule 10, a circumferential strip 39 of the curved top 30 may have a reduced thickness in an amount ranging from about 0.3 mm to about 0.45 mm. This thickness is reduced in comparison to the thickness of the lower portion 32 of the curved top 30. As shown in FIG. 2, circumferential strip 39 may extend from a corner 35 of the curved top 30 toward side wall 30. Strip 39 may be at an angle to a an axis perpendicular to flange 40. Circumferential strip 39 may extend for about 6.7 mm, or a range of about 6 mm to about 8 mm along curved top 30 and in particular along the upper portion 34 of curved top 30.

Another parameter that may facilitate the tight sealing between capsule 10 and the group head (not shown) is the thickness of flange 40. Flange 40 may range in thickness from about 0.5 mm to about 1.1 mm. Furthermore, the present inventor has discovered that by providing the flange to have a diameter (prior to welding of the flange to the lid) ranging from about 36.2 mm to about 36.6 mm, the flange 40, after being welded to the lid (not shown) may have an increased diameter of about 37.0 mm, or within a range of about 36.8 mm to about 37.1 mm.

In one preferred embodiment, the present invention may be described as a coffee capsule for placement in a group head of a coffee-making machine and having an optimal extraction rate, comprising a substantially circular body wall defining a hollow space and having a top end and a bottom end; a curved top meeting the top end of the body wall, the curved top accessible for puncture to define water inlets; a circular flange projecting from the bottom end of the body wall to mate with an outer portion of a lid, a thickness of the flange ranging from about 0.5 mm to about 1.1 mm, the coffee capsule formed of flexible polyproylene copolymer comprising TR50.

The height of coffee capsule 10 from a top surface of the flange to a top of the curved top may be about 28 mm to about 30 mm and may be approximately 0.5 mm higher than standard coffee capsules used in espresso coffee-making machines.

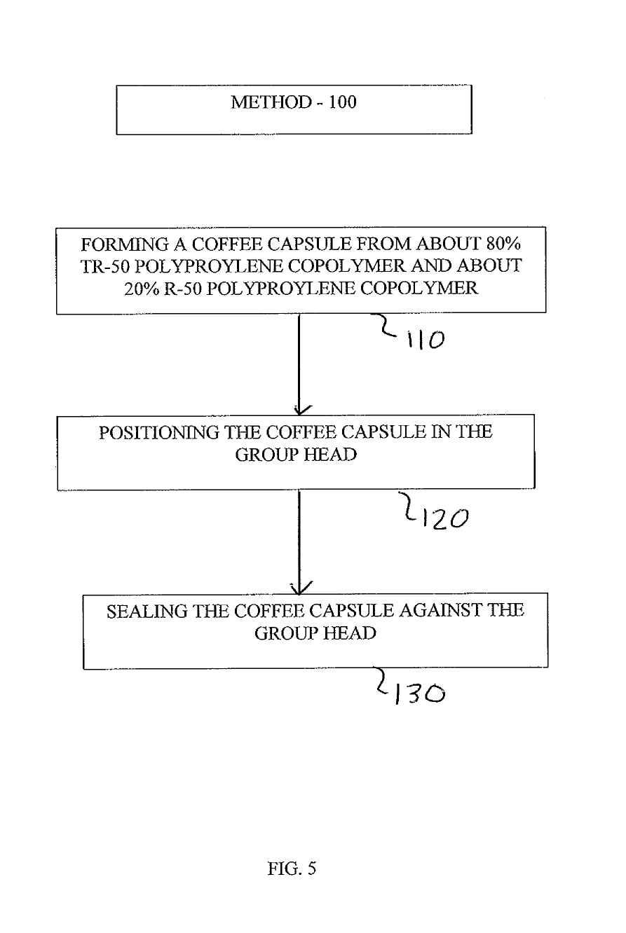

As shown in FIG. 5, the present invention may also be characterized as a method 100 of preparing a group head of a coffee-making machine to brew espresso having an optimal extraction rate. Method 100 may include a step 110 of forming a coffee capsule from about 80% TR-50 polyproylene copolymer and about 20% R-50 polyproylene copolymer. Method 100 may have a further step 120 of positioning the coffee capsule in the group head, and a step 130 of sealing the coffee capsule against the group head.

Some preferred embodiments of method 100 may further include a step of providing a curved top of the coffee capsule with a circumferential strip having a thickness ranging from about 0.3 mm to about 0.45 mm, the circumferential strip situated at a location where blades of the group head puncture the curved top to define water inlets. Some preferred embodiments may also have a further step of providing the circumferential strip at an upper portion of the curved top and providing a lower portion of the curved top with a thickness of between about 0.5 mm to about 0.8 mm. Some preferred embodiments may also have a step of providing the coffee capsule with a circular flange projecting outward from a bottom end of a body wall of the capsule and having a thickness of between about 0.5 mm and about 1.1 mm. A further step may involve sealing the capsule against the group head by providing the flange with an outer step adjacent the body wall projecting upward from a bottom end of the body wall. The method 100 may also include a step of sealing the coffee capsule against the group head by providing the flange with a proximal ridge protruding from a surface of the flange between about 0.4 and about 0.7 mm. The method also include further sealing the capsule against the group head by further providing the flange with a small step between the ridge and the outer step. The small step may have a perpendicular height of between about 0.2 mm and about 0.5 mm above the surface of the flange so that it is smaller than the ridge, which may have a perpendicular height above the surface of between about 0.4 and about 0.7 mm and so that it is smaller than the outer step which may having a substantially vertical length alongside the body wall from between about 2 mm to about 4 mm. The perpendicular height of the small step may be smaller than the height of the ridge by between about 0.1 mm and 0.3 mm, or ideally about 0.2 mm.

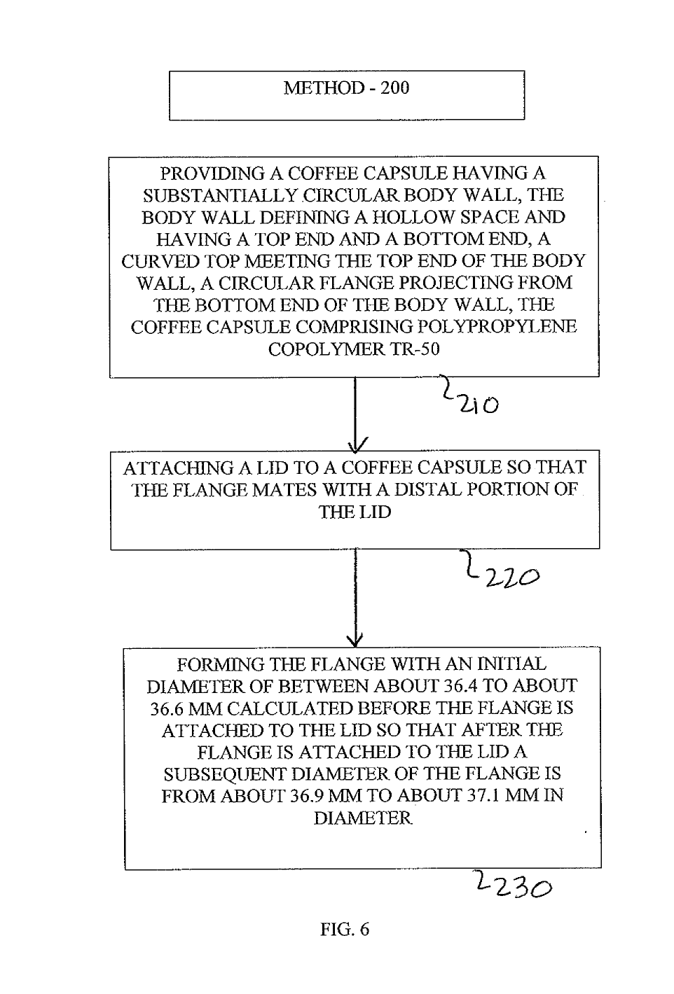

As shown in FIG. 6, the present invention may also be described as a method 200 of making a coffee capsule, comprising a step 210 of providing a coffee capsule (without the lid) having a substantially circular body wall, the body wall defining a hollow space and having a top end and a bottom end, the capsule having a curved top meeting the top end of the body wall and a circular flange projecting from the bottom end of the body wall. The coffee capsule (without the lid) may comprise a polypropylene copolymer, for example TR-50. In one preferred embodiment, it may be about 80% TR-50 and about 20% made of a different harder polyproylene copolymer called R-50. The method 200 may also include a step 220 of attaching a lid to a coffee capsule so that the flange mates with a distal portion of the lid. Method 200 may also have a step 230 of forming the flange with an initial diameter of between about 36.2 to about 36.6 mm calculated before the flange is attached to the lid so that after the flange is attached to the lid a subsequent diameter of the flange is from about 36.8 mm to about 37.1 mm in diameter. Some preferred embodiments of this method 200 may also include a step of attaching the lid by welding the lid to the flange of the coffee capsule.

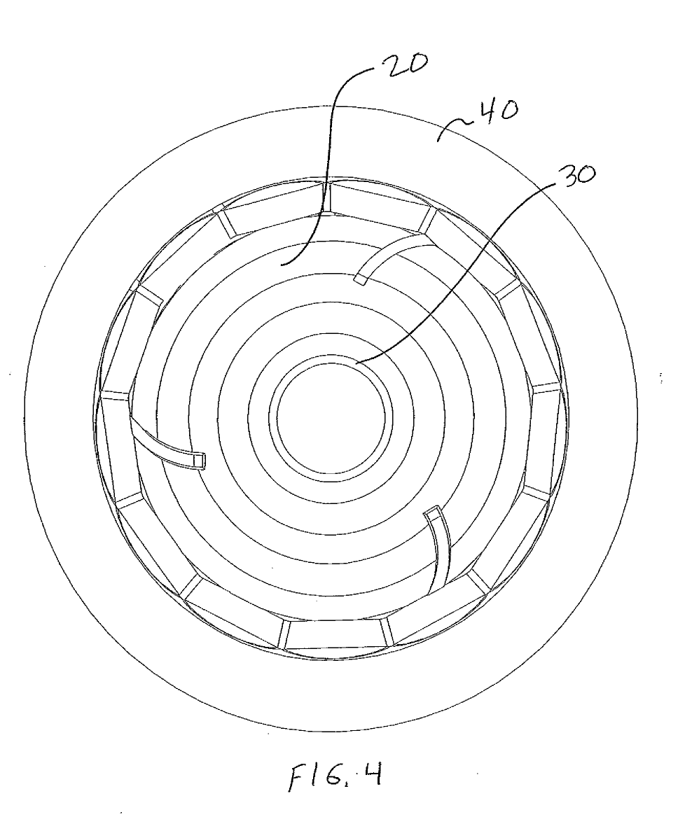

As can be seen from the bottom view of FIG. 4, the capsule 10 may have a series of curved fins on the inside portion of the capsule to increase turbulence of water that flows through the capsule.

In this patent application, the terms “about” or ‘approximately”, when applied to numerical quantities, mean plus or minus five percent of the numerical quantity.

The preferred embodiments have been described separately. Not every detail of the structure of the capsule 10, for example, mentioned with respect top the apparatus embodiment has been repeated for the method embodiments 100, 200. It should be understood, however, that these structural details, although not specifically enumerated in discussing the steps for the method embodiments, may also apply to these method embodiments.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A coffee capsule for placement in a group head of a coffee-making machine and having an optimal extraction rate, comprising:
a substantially circular body wall defining a hollow space and having a top end and a bottom end;
a curved top meeting the top end of the body wall, the curved top configured for puncture to define water inlets;
a circular flange projecting outward from the bottom end of the body wall and configured to mate with an outer portion of a lid, the flange having a proximal ridge protruding from a surface of the flange and forming a seal against water from the group head.

2. The coffee capsule of claim 1, further comprising an outer step adjacent the body wall projecting upward from the bottom end of the body wall.

3. The coffee capsule of claim 2, wherein a small step is situated between the ridge and the outer step, the small step is smaller than the ridge and smaller than the outer step.

4. The coffee capsule of claim 3, wherein the small step has a perpendicular height above the surface of the flange equal to between about 0.2 mm and about 0.5 mm.

5. The coffee capsule of claim 1, wherein the ridge has a perpendicular height above the surface of the flange equal to between about 0.4 and about 0.7 mm.

6. The coffee capsule of claim 1, wherein the outer step having a length alongside the body wall of between about 2 mm to about 4 mm.

7. The coffee capsule of claim 1, further comprising
the coffee capsule formed of polypropylene copolymer comprising TR50.

8. The coffee capsule of claim 7, wherein the copolymer is about 80% TR50 and about 20% R-50.

9. The coffee capsule of claim 1, further comprising
a circumferential strip of the curved top having a thickness in an amount ranging from about 0.3 mm to about 0.45 mm, the thickness reduced in comparison to a thickness of a lower portion of the curved top, the circumferential strip extending from a corner of the curved top toward the side wall and comprising from about 6 mm to about 8 mm.

10. The coffee capsule of claim 1, further comprising
a thickness of the flange ranging from about 0.5 mm to about 1.1 mm.

11. The coffee capsule of claim 1, further comprising
a diameter of the flange prior to welding of the flange to the lid ranging from about 36.2 mm to about 36.6 mm, the flange having a diameter of about 36.8 mm to about 37.1 mm after being so welded.

12. A coffee capsule for placement in a group head of a coffee-making machine and having an optimal extraction rate, comprising:
a substantially circular body wall defining a hollow space and having a top end and a bottom end;
a curved top meeting the top end of the body wall, the curved top accessible for puncture to define water inlets;
a circular flange projecting from the bottom end of the body wall to mate with an outer portion of a lid, a thickness of the flange ranging from about 0.5 mm to about 1.1 mm,
the coffee capsule formed of flexible polyproylene copolymer comprising TR50.

13. The coffee capsule of claim 12, further comprising
the curved top having a lower portion, an upper portion and a top,
a circumferential strip of the upper portion of the curved top having a thickness in an amount ranging from about 0.3 mm to about 0.45 mm, the thickness reduced form a thickness of the lower portion of the curved top, the circumferential strip extending from about 6 mm to about 8 mm.

14. The coffee capsule of claim 12, further comprising
a diameter of the flange prior to welding of the flange to the lid ranging from about 36.2 mm to about 36.6 mm, the flange having a diameter of about 36.8 mm to about 37.1 mm after being so welded.

15. The coffee capsule of claim 12, further comprising
a height of the coffee capsule from a top surface of the flange to a top of the curved top is about 28 mm to about 30 mm.

16. A method of preparing a group head of a coffee-making machine to brew espresso having an optimal extraction rate, comprising:
forming a coffee capsule from about 80% TR-50 polyproylene copolymer and about 20% R-50 polyproylene copolymer;
positioning the coffee capsule in the group head; and
sealing the coffee capsule against the group head.

17. The method of claim 16, further comprising
providing a curved top of the coffee capsule with a circumferential strip having a thickness ranging from about 0.3 mm to about 0.45 mm, the circumferential strip situated at a location where blades of the group head puncture the curved top to define water inlets.

18. The method of claim 17, further comprising
providing the strip at an upper portion of the curved top and providing a lower portion of the curved top with a thickness of between about 0.5 mm to about 0.8 mm.

19. The method of claim 16, further comprising
providing the coffee capsule with a circular flange projecting outward from a bottom end of a body wall of the capsule and having a thickness of between about 0.5 mm and about 1.1 mm.

20. The method of claim 19, further comprising
further sealing the capsule against the group head by providing the flange with an outer step adjacent the body wall and projecting upward from the bottom end of the body wall.

21. The method of claim 20, further sealing the capsule against the group head by further providing the flange with a proximal ridge.

22. A method of making a coffee capsule, comprising:
providing a coffee capsule having a substantially circular body wall, the body wall defining a hollow space and having a top end and a bottom end, a curved top meeting the top end of the body wall, a circular flange projecting from the bottom end of the body wall, the coffee capsule comprising a polypropylene copolymer;
attaching a lid to a coffee capsule so that the flange mates with a distal portion of the lid; and
forming the flange with an initial diameter of between about 36.2 to about 36.6 mm calculated before the flange is attached to the lid so that after the flange is attached to the lid a subsequent diameter of the flange is from about 36.8 mm to about 37.1 mm in diameter.

23. The method of claim 22, further comprising attaching the lid by welding the lid to the flange of the coffee capsule.

24. The method of claim 22, further comprising providing the coffee capsule so that the coffee capsule comprises polypropylene copolymer TR-50.
